(19) United States
(12) Patent Application Publication
(10) Pub. No.: US 2006/0027062 A1
(43) Pub. Date: Feb. 9, 2006

(54) Hexagon and shape cutting template

(76) Inventor: Jason William Whaley, Casper, WY (US)

Correspondence Address: Jason Whaley, 301 Thelma Drive #424, Casper, WY, 82609, US

(21) Appl. No.: 10/913,824

(22) Filed: Aug. 7, 2004

(51) Int. Cl. B26D 1/00

(52) U.S. Cl. 83/13; 83/455

(57) ABSTRACT

A cutting template for use in cutting various shapes, of various sizes, into or out of a specified medium. A preferred substrate for the invention includes a sheet of plastic or similar material with two grooves completely through the substrate that define the edge of the shape, and additional markings on the sheet to define sizes and registration. The grooves function to guide a cutting instrument that extends through the sheet into the medium to be cut, eliminating any need for tracing a pattern onto the medium. The plastic or similar material sheet shall be translucent or transparent sufficient to see the registration markings and the material the device is placed upon.

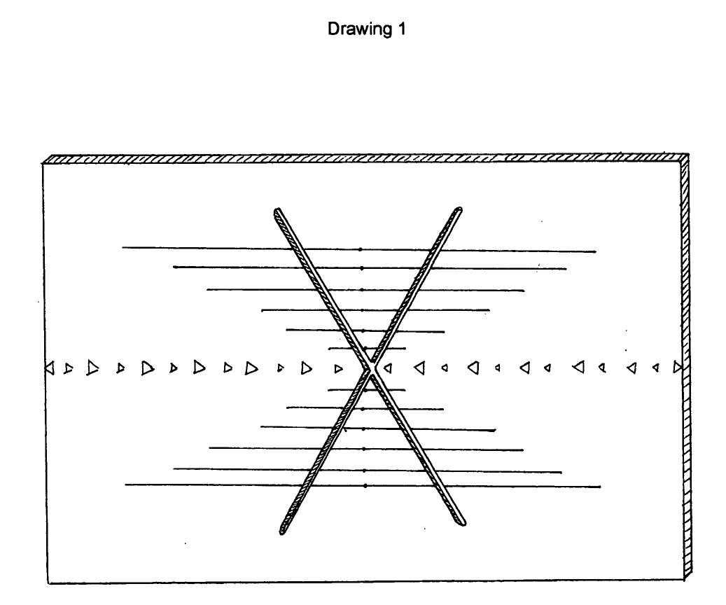

### BACKGROUND OF THE INVENTION

1. Field of the Invention

The invention relates to cutting material into selected shapes. To be more specific, the invention relates to templates for guiding a cutting instrument for cutting selected materials so as to produce selected shapes.

2. Discussion of Related Art

Many hobbies and professions involve sizing or shaping materials. For example, those who make quilts will often cut textile fabric into shapes prior to sewing them together in a larger conglomeration. Size, registration, and speed all are involved in various degrees in making these shapes. Frequently fabric artists must define the shape onto fabric using a washable pencil or marker.

Unfortunately, methods involving marking on fabric with a washable pencil or marker are laborious and exceedingly time-intensive. Similarly, current devices available to speed this process along are time-intensive, and do not easily allow for “in-between” sizes, wherein a specific intended size of shape is smaller or larger than the current template design allows.

What is needed is a device that addresses accuracy of registration, great variation in size of final shape, and the speed to complete these tasks with a minimum of labor intensiveness and time. This invention seeks to eliminate the marking step in favor of a significantly faster registration process and method, and represents achievements over and above those currently which demonstrate a lacking in the art of shape cutting; additionally this device allows for the near-infinite use of “in-between” sizes in comparison to devices currently in the public use and domain.

### SUMMARY OF THE INVENTION

The invention provides a cutting template of unique design for use in cutting a selected medium in sheet form so as to create a selected pattern or shape, specifically a hexagon, trapezoid, or triangle. The invention also provides a method of using such templates so as to cut selected shapes in a selected medium. The template may be used to cut out pieces of selected shapes and sizes for mounting on a separate substrate. The template also allows for a wide range of sizes to be cut out of a selected medium. The template is preferably made of a transparent or translucent plastic, polycarbonate or similar material which allows for visual placement of template relative to medium for specific accurate registration during alignment and cutting of medium. The invention provides optimal cutting grooves that guide a cutting blade so as to assure precision cutting. As described below under Method of Use, it will also be apparent that greatly increased speed of cutting is achieved by use of this invention as compared to other inventions in the field.

Other features and advantages of the invention are described in or rendered obvious by the drawings submitted with this document.

### BRIEF DESCRIPTION OF THE DRAWING

Drawing 1 depicts a “perspective” view of the invention such that it may be discerned in three dimensions, and generally from the user's line of sight.

### DETAILED DESCRIPTION OF THE INVENTION

Manufacture: The invention is made of plastic material sufficiently clear to allow the user to read the registration marks and see the material to be cut below it. As a variety of types of plastic material (acrylic, polycarbonate, etc) could conceivably be used, the method of manufacture of the plastic substrate is specific to the manufacturer of the product selected. The invention is made by computer-numerically-controlled and/or laser machining of planar plastic sheets, or by standard injection molding practices. The “front” side (that which the user faces directly during use) is typically milled by CNC machine, so as to cut the beveled channels of the template's pattern. The indicia for registration and measurement are engraved or laser etched into the back side of the substrate to minimize parallax for the end user. The CNC mill and/or laser is directed with an electronic document or similar file and operated per the functions of said mill or laser engraving device.

Improvements over prior methods: Other methods used for marking and cutting hexagons and similar shapes (trapezoids, triangles), typically involve one of two methods. The first is a plastic stencil—the user lays the stencil upon the fabric, marks it with a pencil, chalk or pen (typically of a material that washes away), and does this repeatedly for the number of shapes needed; the user then cuts the fabric using any available means (scissors, rotary cutter, etc), and sets aside the usable shapes needed. The second method involves solid outline shapes, of hexagons, trapezoids, triangles, etc; typically made of a plastic material. Using this method the user lays the solid shape upon the fabric and cuts it out directly with a rotary cutter, or marks the fabric as previously described and cuts it with any available means. Both of these steps are very laborious—they cannot easily make cuts through several layers with accurate registration, they can be wasteful, they cannot account for sizes other than those exactly provided by their methods (“in-between sizes”), and they take significant time to perform the multitude of steps. This device eschews multiple labor steps in favor of a brisk registration and cutting process. By providing such accurate registration and removing the marking step, this allows the end user to cut through a number of layers of underlying fabric at once when using a rotary knife. By removing the marking step and allowing multiple layers to be cut at once, the time required to cut shapes sufficient for one's project may be quite radically reduced. This could also reduce activity-related strain due to time spent on activity, provided the ergonomics of the user's workstation are functional to such a degree.

Method of Use: The invention is intended to cut a variety of shapes of various sizes with rapid and accurate registration. Due to its unique shape, a method must be defined so the user can become familiar with its operation. Each of three methods are described below for cutting hexagons, trapezoids and triangles.

Cutting Hexagons: the user must predetermine the size of the hexagon, which is intended for their needs. For the purposes of an example, a three inch (3″) hexagon will be used in this written demonstration, although hexagons of varying sizes may be cut using this invention.

The user must cut strips of the selected medium that correspond with the “3” line on the template. This is not truly three inches, rather it is a width determined by the ratio of the maximum length to minimum width of a hexagon, the 3″ definition is the long axis of the hexagon, which will be greater than the short axis which is the reference for width in this case. When the strips are cut, they are laid in a horizontal fashion on a table or similar surface so that they may be cut. Ideally a mat, which prevents cutting of the underlying table, could be used, but this is to be determined by the user based upon their needs. The template is laid upon the strips, and the strips are registered between the “3” lines on the template. The template is slid down to one end, and the center of the fabric strip is placed in the center of the “X” formed by the cutting grooves; cuts are then made with a cutting implement using the cutting grooves to cut the end of the strip into a broad point. The template is then moved laterally until the center of the broad point that had just been cut is now placed on the point of the registration triangle marked with a “3”. This movement ensures accurate distance of the long axis of the hexagon. The cutting implement is then brought back into contact with the specified medium through the cutting grooves, and the medium is cut. This will serve two functions—one, it will cut free a hexagon from the specified medium; two, it will form another broad point for registering the next hexagon as the first one was registered. The process is then repeated—align the broad point with the “3” triangle registration mark, and cut the medium again. Multiple layers of medium may be cut simultaneously to improve speed, provided the cutting implement may be pushed through them, and the user is safe in doing so. Other sizes may be cut using this template, substituting the “3” used in the example above with the necessary size or fractional size required by the needs of the user.

Cutting Trapezoids: The subject will cut strips of the preferred medium that align with the preferred registration lines on the template. When the strips are cut, they are laid in a horizontal fashion on a table or similar surface to be cut. Ideally a mat preventing cutting of the underlying table could be used, but this is to be determined by the user based upon their needs. The template is laid upon the strips, and the strips are registered between the preferred registration lines. The template is slid down to one end, and the center of the fabric strip is placed in the center of the “X” formed by the cutting grooves; cuts are then made with a cutting implement using the cutting grooves to cut the end of the strip into a broad point. The template is then moved laterally until the top and bottom edges of the cuts that had been made are just within the area defined by the cutting groove. This movement ensures accurate distance of the short axis of the trapezoid. The cutting implement is then brought back into contact with the specified medium through the cutting grooves, and the medium is cut. This will serve two functions—one, it will cut free a trapezoid from the specified medium; two, it will form another broad point for registering the next trapezoid as the first one was registered. The process is then repeated—align the top and bottom edges of the now-cut medium with the edge of the cutting groove, and cut the medium again. Multiple layers of medium may be cut simultaneously to improve speed, provided the cutting implement may be pushed through them, and the user is safe in doing so.

Cutting Equilateral Triangles: the user must predetermine the size of the triangle which is intended for their needs.

The user must cut strips of the selected medium that correspond with the line on the template and the center of the “X” defined by the cutting grooves; specifically the true size of the triangle will be half the number represented by the registration mark (eg, a 3″ triangle will correspond to the 6″ registration mark). This discrepancy between the intended size and the registration line number is required due to the triangle being half the width of the intended hexagonal shape for which this template is primarily defined. When the strips are cut, they are laid horizontally on a table or similar surface to be cut. Ideally a mat preventing cutting of the underlying table could be used, but this is to be determined by the user based upon their needs. The template is laid upon the strips, and the strips are registered between the registration line and the center of the “X” formed by the cutting grooves. The template is then slid down to one end, and cuts made using a cutting implement through the cutting grooves. A right triangle of the specified medium will be formed from the first cut which can be discarded if not useful to the user. The template is then moved laterally until the bottom edge of the now-cut triangle is just touching the bottom of the opposite cutting groove (eg, the ‘left’ side of the triangle is now touching the ‘right’ cutting groove). This movement ensures accurate distance of the side of the triangle. The cutting implement is then brought back into contact with the specified medium through the cutting grooves, and the medium is cut. This will serve two functions—one, it will cut free a pair of triangles from the specified medium; two, it will form another edge for the next triangle as the first one was registered. The process is then repeated—align the cut edge of the triangle with the opposite cutting groove, and cut the medium again. Multiple layers of medium may be cut simultaneously to improve speed, provided the cutting implement may be pushed through them, and the user is safe in doing so. Other sizes may be cut using this template, substituting the “6” used in the example above with the necessary size or fractional size required by the needs of the user.

I claim:

1. A template for cutting a medium with a sharp blade comprising:
A flat sheet of plastic or similar material having planar first and second sides contiguous with a perimeter of said panel, said panel also having a pair of channels adapted to receive and maintain a cutting edge for cutting a material, these channels formed in the shape of an X with 60 degrees of angle measurement comprising the acute angle and 120 degrees of angle measurement comprising the obtuse angle measurement.

2. The template of claim 1 shall have registration marks intended for locating said template relative to the medium intended to be cut.

3. The channels in the shape of an X in claim 1 shall have sufficient width to support a blade used in cutting intended medium

4. A method for cutting a medium using the template in claim 1 comprising:
a. Providing a template in the form of a flat sheet having planar sides coextensive with a perimeter of the sheet and having a pair of channels which form an X in the template for registration of the cuts relative to the medium intended to be cut.
b. Positioning said template over or upon a selected medium
c. Inserting a cutting blade into one channel insofar as to maintain contact between the blade and the medium to be cut
d. Drawing the cutting blade across the medium sufficiently to make complete cut, transecting the cut portion from the remainder of the medium, while having lateral constraint of movement against the sides of the channels in the template of claim 1.
e. Repeating steps C and D in the other channel of the template sufficient to create a pair of cuts through the medium intended to be cut.
f. Moving the template across the medium in a fashion parallel with the medium to a specific location based on the user's needs and verified through the registration marks on the template.
g. Repeating steps C through F until the medium to be cut has been exhausted or enough has been cut based upon the user's needs.
